(19) United States
(12) Patent Application Publication
(10) Pub. No.: US 2003/0226657 A1
(43) Pub. Date: Dec. 11, 2003

(54) Food delivery system and method for storing and heating food to a serving temperature

(76) Inventor: Thomas E. Wallace, Charlotte, NC (US)

Correspondence Address: KENNEDY COVINGTON LOBDELL & HICKMAN, LLP, 214 N. TRYON STREET, HEARST TOWER, 47TH FLOOR, CHARLOTTE, NC, 28202, US

(21) Appl. No.: 10/113,708

(22) Filed: Apr. 1, 2002

(51) Int. Cl. B60H 1/00

(52) U.S. Cl. 165/202

(57) ABSTRACT

An improved food delivery system for storing and heating of food prior to service, particularly for bulk food service at banquets, catered events and institutional applications. A transportable cart or like food storage unit has a multi-function food treatment system capable of chilling the food storage enclosure of the cart, heating the enclosure by convection or conduction only, or heating the enclosure by convection and conduction simultaneously, accordingly to a selective operating sequence, timing and duration determined by a programmable control system.

### BACKGROUND OF THE INVENTION

The present invention relates generally to food delivery systems and methods and, more particularly, to an improved multi-function food delivery system and method for preparation and delivery of food at a serving temperature via a transportable food storage unit.

The food preparation and service industry has grown rapidly over recent years, with ever increasing demands for consistent food quality, efficiency and cost effectiveness. These issues are particularly important in the preparation and service of food in large quantities for service to a large number of people, e.g., institutional food preparation and service such as in hospitals, nursing homes, and similar institutions, catered food preparation and service for large events such as weddings and the like, and other bulk food preparation and service such as for banquets and similar gatherings. In many such situations, it is beneficial, if not necessary, that the food preparation and cooking occur in bulk prior to the event and at a location remote from the event, which only heightens the logistical difficulties of insuring that the food will be fully cooked but not overcooked, delivered at an optimal serving temperature, and well presented.

A variety of food preparation and delivery systems have been developed in the past to address these issues. A common approach is to provide one or more carts or cabinets for food storage, delivery and heat maintenance. Examples of such cabinets are disclosed in U.S. Pat. Nos. 4,180,125; 4,346,756; 4,560,859; RE30,623; 5,403,997; 5,404,935; 5,520,102; 5,628,241; and 6,034,355. Some such food storage units are equipped with combined cooling and heating means by which the food can preliminarily be stored under chilled conditions and then subsequently cooked or warmed to a serving temperature with the same unit. Examples of such structures are disclosed in U.S. Pat. Nos. 4,316,078 and 5,975,202. Many of such cabinets and food storage units are supported on wheels, casters or the like to facilitate transportation of the food from one location to another, e.g., from a food preparation location to a different remote food service location.

Although in many respects these known cabinets and food storage units perform satisfactorily for their intended purposes, a need nevertheless still exists for a food delivery system and method having more expanded and flexible capabilities.

### SUMMARY OF THE INVENTION

It is accordingly an object of the present invention to provide an improved food delivery system and method for storing and heating food to a serving temperature, which provide expanded and enhanced capabilities with greater flexibility for selective operation than known food delivery systems and methods.

A more particular object of the present food delivery system and method is to provide the selective capability of chilling of food under refrigerated conditions and heating of food by differing or combined means within a single food storage unit. A related object of the food delivery system and method is to provide a food storage unit capable of handling food already prepared into individualized meals on serving plates or food in bulk form, e.g., within larger food cooking/service pans such as used by institutions, hotels, banquet facilities and caterers.

Briefly summarized, the present food delivery system and method addresses these objects by providing a transportable food storage unit which defines an enclosure for containing a food item. A food treatment system is associated with the food storage unit for determining the food treatment conditions within the enclosure of the food storage unit. More particularly, the food treatment system comprises an arrangement for chilling the enclosure sufficiently to preserve temporarily the food item within the enclosure against spoilage, an arrangement for heating by conduction the food item within the enclosure, and an arrangement for heating by convection the food item within the enclosure. A programmable control system is provided for controlling operation of the food treatment system and, in particular, is adapted for selectively determining an operating sequence, timing and duration of the chilling, conduction and convection arrangements according to the food item.

Advantageously, the transportable food storage unit may be embodied in the form of a food service cart, the enclosure of which may preferably be adapted to support individualized meals on respective serving plates or bulk food cooking pans, or both. The food storage unit may also comprise a second enclosure which is continuously chilled by the chilling arrangement to contain other food items which do not require heating.

The programmable control system is preferable arranged to execute operation of the food treatment system selectedly in differing modes, such as a mode for rethermalizing previously cooked food to a serving temperature, another mode for holding previously cooked food at a serving temperature, or a mode for cooking uncooked food to a serving temperature.

For example, the programmable control system may execute operation of the food treatment system in a sequence wherein the chilling arrangement is initially actuated for a pre-determined period of time, and thereafter the convection and conduction heating arrangements are actuated simultaneously for a subsequent period of time, which methodology is particularly useful and advantageous, for example, for storing previously cooked food and then subsequently rethermalizing the food for serving. In some modes of operation, it will be additionally advantageous for the programmable control system to actuate the convection heating arrangement for a predetermined period of time in advance of the simultaneous actuation of the convection and conduction heating arrangements. In other modes of operation, it may be advantageous for the programmable control system to actuate only the convection heating arrangement.

The food delivery system and method of the present invention is particularly applicable to the preparation of food at a location remote to the serving location, at which the food may be loaded into the enclosure of the food storage unit, either as individualized meals on respective serving plates or in bulk form in food preparation pans, and then transported to the serving location.

Other objects features and advantages of the food delivery system and method of the present invention will be described and understood from the following description of preferred embodiments with reference to the accompanying drawings.

### BRIEF DESCRIPTION OF THE DRAWINGS

FIG. 1 is a perspective view of a food delivery system in accordance with one preferred embodiment of the present invention;

FIG. 2 is a simplified schematic diagram of the relevant mechanical and electrical operating components of the food delivery system of FIG. 1;

FIG. 3 is a horizontal cross-sectional view taken through the food delivery system of FIG. 1 along line 3-3 thereof;

FIG. 4 is a simplified flow chart representing the operational methodology of the food delivery system of FIG. 1 according to selectively differing modes of operation; and

FIG. 5 is a perspective view of a food delivery system in accordance with one preferred embodiment of the present invention.

### DETAILED DESCRIPTION OF THE PREFERRED EMBODIMENTS

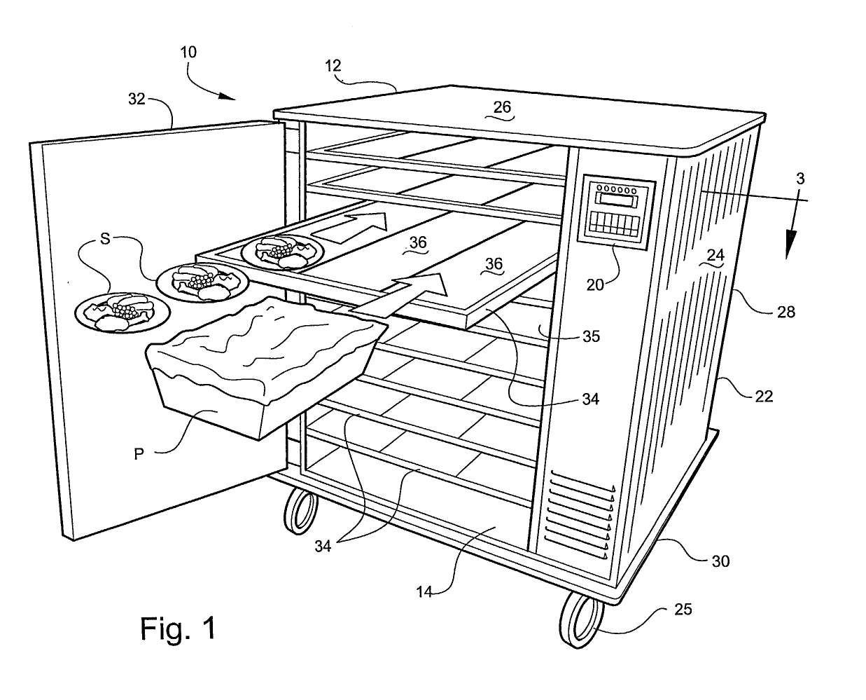

Referring now to the accompanying drawings and initially to FIG. 1, a food delivery system according to the present invention is indicated generally at 10 in one contemplated embodiment taking the form of a transportable food storage unit, such as a mobile wheeled food delivery cart 12 defining a food treatment and storage enclosure 14 within the interior of the cart 12. The cart or other food storage unit 12 is equipped with a multi-function food treatment system, generally indicated at 16 in FIG. 2, by which the interior food treatment/storage enclosure 14 of the food storage unit 12 may be selectively chilled or heated in order to determine differing food treatment conditions within the enclosure, all as more fully explained below. Further, the cart or other food storage unit 12 is provided with a microprocessor-based or other programmable control system, generally indicated at 18 in FIG. 2, operatively connected to a combined display and control panel 20, e.g., mounted on the front wall of the cart 12, by which the food treatment system may be selectively controlled, e.g., by selectively determining the operating sequence, timing and duration of chilling and heating operation of the food treatment system in varying operational modes, typically as determined according to the food item or items within the food storage unit 12.

As best seen in FIG. 1, the cart form of the food storage unit 12 comprises a rectangularly parallelepiped housing 22 having opposite vertically-oriented parallel side walls 24, a vertically-oriented rear wall 28 extending between the side walls 24, and top and bottom walls 26, 30, respectively, extending between and connecting the upper and lower ends of the side and rear walls 24, 28, thereby defining the food treatment and storage enclosure 14 therewithin and an open front 30 for access into the enclosure 14. An access door 32 is hinged to the housing 22 for opening and closing access into the enclosure through the open front 30. For ease of transportability, the housing 22 of the food storage unit 12 is supported on wheels or casters 25.

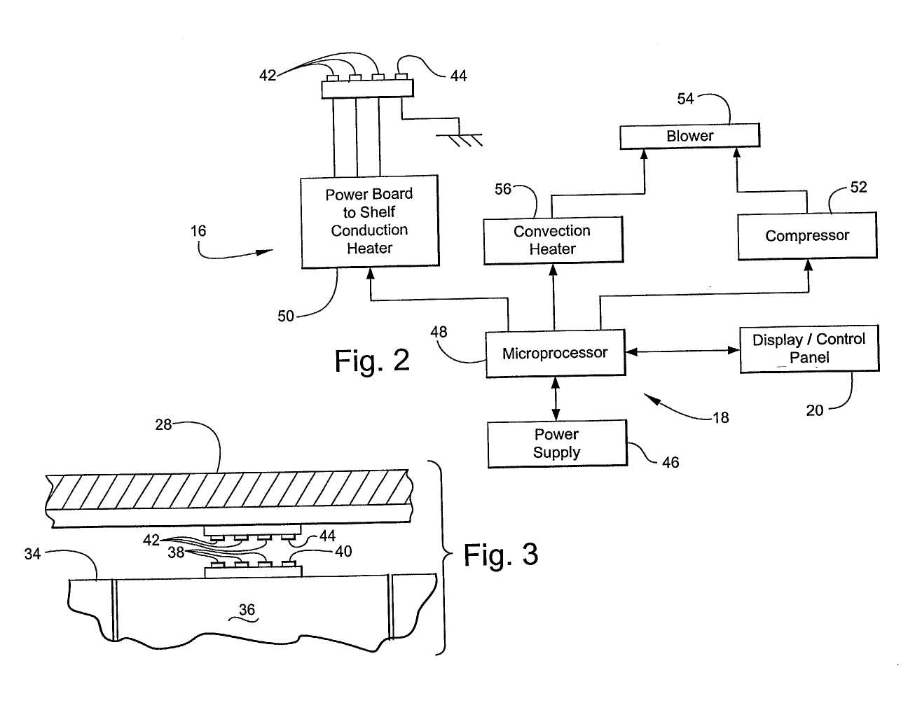

Within the enclosure 14, a plurality of shelves 34 are horizontally oriented in spaced parallel relation for sliding movement into and out of the enclosure 14 via the open front 30 when the door 32 is in its opened position. Each shelf 34 includes a plurality, preferably three, of substantially flat plate-like electrically-actuated conduction heating units 36 arranged in side-by-side substantially coplanar relationship to define the upper food support surface of the respective shelf 34. As best seen in FIG. 3, each shelf is provided with a series of electrical contacts 38, 40, for contact with four corresponding electrical contacts situated interiorly on the rear wall 26 of the housing 22 for abutting engagement of the respective contacts 38, 40 with the contacts 42, 44 when the shelf 34 is fully withdrawn into the enclosure 14 of the cart 12, as depicted in FIG. 3. The respective contacts 38, 42 provide active electrical power supply to the three respective conduction heating units 36 of the respective shelf 34, while the contacts 40, 44 provide grounding for the conduction heating units 36.

More particularly, the conduction heating units 36 of each shelf 34 provide a suitably flat upper surface of an appropriate dimension adapted for supporting rectangular food cooking and service pans of the conventionally standard size typically utilized by hotels, caterers and other banquet service providers, such as represented by the pan P shown in FIG. 1, the upper surface of each shelf 34 as defined by its conduction heating units 36 preferably being capable of supporting two such pans P in side-by-side relation. Alternatively, the flat upper surface presented by each shelf 34 is equally adapted to support other forms of cookware, including serving plates S on which individual serving portions of differing food items may be placed to provide an individualized meal serving on each such plate S, as also represented in FIG. 1. The conduction heating units 36, in known manner, are adapted to apply warming or cooking heat by direct conduction to the respective pan(s) P or plate(s) S supported on the respective shelf 34. Although FIG. 1 depicts for sake of illustration the placement of both a pan P and serving plates S into the cart 12 at the same time, it will be understood that, in normal operations of the cart 12, the differing modes of operation of the food treatment system 16 and the programmable control system 18 will ordinarily be adapted to handle pans P and plates S separately but typically not together (although such is nevertheless possible as hereinafter indicated).

The other major operating components of the food treatment system 16 and the programmable control system 18 are contained within the side and rear portions of the housing 22 adjacent the food treatment and storage enclosure 14. Since these operating components individually are conventional, the components are depicted in FIG. 2 only schematically by way of a block diagram representing the operating relationship between the components. The cart 12 is equipped with a power supply, only generally indicated at 46, which may be an on-board storage battery (not shown) or, alternatively or in addition, the cart 12 may be equipped with a power cord (also not shown) for connection to a standard alternating current electrical outlet. The programmable control system 18 includes a programmable microprocessor, indicated only generally at 48, connected with the display and control panel 20 for inputting of operational instructions therefrom and for transmitting thereto a display of relevant information concerning prevailing operational conditions. Electrical power is transmitted selectively via the microprocessor and therefrom via a circuit board 50 to the individual conduction heating units 36 of the shelves 34, whereby the individual conduction heating units 36 of each respective shelf 34 may be individually and separately controlled, as more fully explained hereinafter.

The food treatment system 16 additionally includes an arrangement for chilling the interior enclosure 14 of the cart 12 by circulation therein of refrigerated air, and a comparable arrangement for convection heating of the interior enclosure 14 of the cart 12 by circulation therein of heated air. More specifically, the food treatment system 16 includes a refrigeration condenser or compressor arrangement, only schematically indicated at 52, in conjunction with a blower 54 for withdrawing air from the interior enclosure 14, chilling the air via the compressor 52, and returning the chilled air into the enclosure 14, on a continuing basis to lower the prevailing temperature within the enclosure 14 to a desirable refrigerated temperature, e.g., typically 35 to 39° F., under the operational control of the microprocessor 48. Similarly, the food treatment system 16 includes a convection heating unit 56 connected with the blower 54 for withdrawing air from the enclosure 14, heating the air via the convection heating unit 56, and then returning the air via the blower 54 into the enclosure 14 on a continuing circulated basis via the control of the microprocessor 48 to elevate the interior temperature of the enclosure 14 to a desired convection heating/cooking temperature.

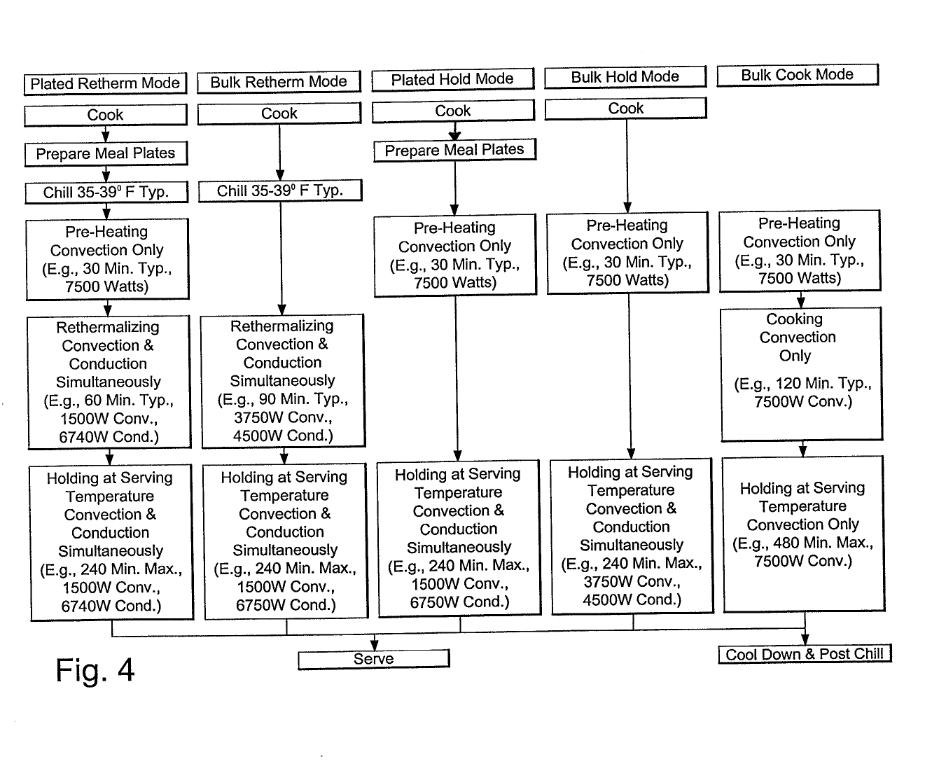

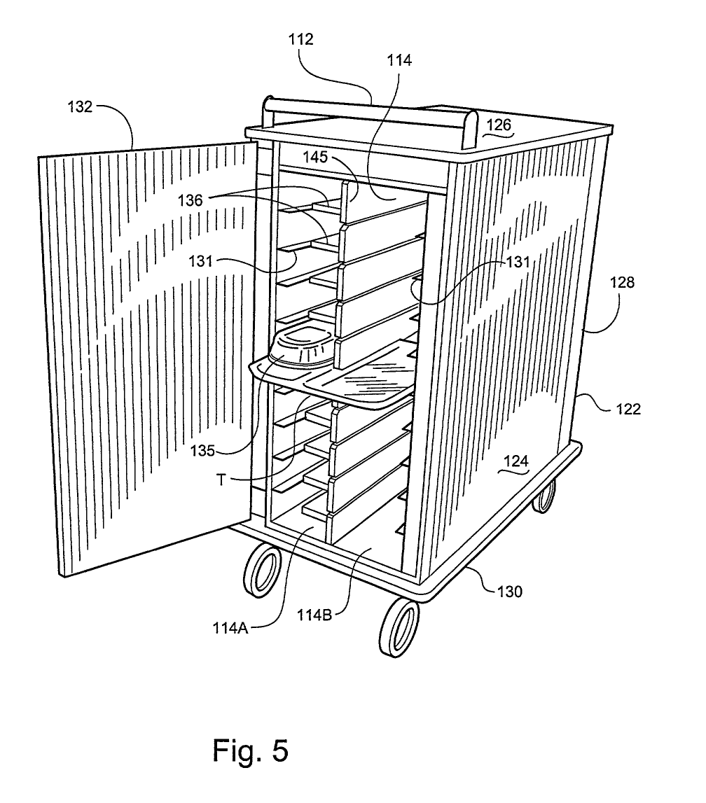

In accordance with the present invention, the food treatment system 16 in conjunction with the programmable control system 18 provides substantial flexibility and variability in the operation of the food delivery system 10 and, in particular, enables the food delivery system 10 to operate in numerous differing modes of operation, such as represented by way of example but without limitation in the flow chart diagram of FIG. 4. As persons skilled in the art will likely recognize, the operational conditions required to rethermalize, i.e., bring back to an appropriately warmed serving temperature, food which has been previously cooked and then subsequently chilled will require differing operational conditions of the food delivery system 10 than holding at the appropriate serving temperature food which has been cooked but not chilled. As will further be understood, the rethermalization of previously cooked food may require differing operational conditions of the food delivery system 10 depending upon whether the food has been separated into individualized meal portions placed on respective serving plates or is to be rethermalized in bulk form with the food still contained within pans. Further, the operational conditions required of the food delivery system 10 for actually cooking uncooked food to an appropriate fully cooked serving temperature will require still further operational conditions of the food delivery system 10. The food delivery system 10 via the multi-function food treatment system 16 in connection with the programmable control system 18 is uniquely capable in accordance with the present invention of selective operation in each of these modes.

Thus, by way of example but without limitation, FIG. 4 depicts these differing operational modes of the food delivery system. In a first mode, designated as “Plated Retherm Mode,” food for a planned meal, e.g., a banquet which will include a meat entree, and two differing vegetables, is precooked by conventional means, e.g., the meat entree cooked in bulk in a large pan such as the pan P and, similarly, the two vegetables separately precooked in bulk form in their own respective pans P. The cooking will typically take place one to several days in advance of the scheduled banquet and, hence, once cooked, the pans of food will then be placed into a so-called chiller and refrigerated to a very low temperature just above freezing. At a pre-designated time in advance of the scheduled banquet, the respective pans of food are removed from the chiller and the entree and vegetables are divided into individual meal portions and placed on serving plates S which are then placed onto the shelves 34 within the cart 12, as represented schematically in FIG. 1. The microprocessor 48 is then programmed to operate the cart 12 under substantially the same chilled condition for a pre-designated period of time, after which the microprocessor 48 will then deactivate the condenser 52 and actuate a preheating of the enclosure 14 to raise the temperature within the enclosure 14 to a designated temperature to begin the rethermalization process, e.g., to essentially a room temperature range. This step is preferably accomplished via actuation exclusively of the convection heating unit 56 in conjunction with the blower 54 to heat the enclosure 14 only convectively. Thereafter, the rethermalization process begins by actuating the conduction heating units 36 of each shelf 34 while simultaneously continuing the actuation of the convection heating unit 56 and the blower 54. Depending upon the particular food items making up the meals on the serving plates S, it will often be advantageous and appropriate to reduce the wattage applied to the convection heating unit 56 so as to appropriately balance the amount of convection heating and the amount of conduction heating applied to the food items. The rethermalization process is programmed to conclude at the planned time of the banquet or shortly in advance of the banquet and, in the latter case, the microprocessor 48 will be programmed to switch to a holding operation of the convection and conduction heating units 36, 56 so as to maintain the serving temperature of the meals.

The “Bulk Retherm Mode”, i.e., the mode of operation adapted to rethermalize food still contained in bulk form in the pans P in which the food was originally cooked, is similar in its preferred sequence of steps, as represented in FIG. 4, except that the preheating step by convection only heating via the convection heating unit 56 may be eliminated and, as will often be necessary due to the bulk form of the food, the rethermalization step will typically take a longer period of time to complete and may also be benefited by operating the conduction and convection heating units 36, 56 at different power levels (i.e. wattages) than are utilized in the “Plated ReTherm Mode.”

In FIG. 4, the “Plated Hold Mode” and the “Bulk Hold Mode” represent the previously-indicated modes of operation wherein previously cooked food is placed directly into the cart 12, either still within the cooking pans P or after first being portioned into individualized meals on serving plates S, without any intervening chilling stage and without any operation of the chilling arrangement of food treatment system 16, for the purpose of holding the food in its cooked condition at the desired serving temperature. In each mode of operation, the interior enclosure 14 of the cart 12 is initially preheated via actuation of the convection heating unit 56 and the blower 54 only (i.e., without any coordinated operation of the conduction heating units 36). Thereafter, once the enclosure 14 reaches the appropriate desired internal temperature, the convection heating unit 56 and the conduction heating units 36 are simultaneously actuated to hold the food at the designated serving temperature. Hereagain, with food retained in bulk form in cooking pans P, the power level (i.e., wattage) at which the convection and conduction heating units 36, 56 are operated may need to be varied from that which is desirable to hold at serving temperature food which is already portioned onto serving plates S.

As also previously indicated, the multi-function capabilities of the food treatment system 16 provide the additional unique capability to the food delivery system 10 of enabling uncooked food to be fully cooked to and maintained at a serving temperature all within the enclosure 14 of the cart 12. Typically, in such a cooking mode of operation, the food will optimally be cooked in bulk form in food cooking pans P, whereby this exemplary mode of operation represented in FIG. 4 is designated as the “Bulk Cook Mode.” As represented in FIG. 4, this mode of operation will typically entail an initial preheating of the enclosure 14 via actuation of the convection heating unit 56 and the blower 54 only (i.e., without any coordinated or simultaneous actuation of the conduction heating units 36), and subsequently this convection only operation of the food treatment systems 16 will continue for a sufficient period of time to fully cook the food. Upon completion of the cooking operation, the microprocessor 48 may be programmed to continue the actuation of the convection heating unit 56 to hold the cooked food at its serving temperature for a short period of time, e.g., one to several hours, until a designated serving time, or alternatively, the convection heating unit 56 may be deactuated and the condenser 52 actuated to begin chilling of the enclosure 14 to hold the cooked food in a chilled refrigerated environment in the event the food is not to be served until substantially later.

As will thus be appreciated by those persons skilled in the art, the food delivery system 10 of the present invention provides substantially expanded capabilities and significantly enhanced flexibility in the preparation of food for service to large groups, such as banquets and like, in comparison to the capabilities of the food cooking equipment and methods heretofore known and used. Specifically, the present food delivery system 10 may, in and of itself and without any other equipment, potentially be utilized to originally cook food in bulk form for banquets, catered events and like gatherings, to then chill and hold the food for a pre-designated period of time and then rethermalize the food for service. Alternatively, food precooked at any other location may be loaded into the cart 12 of the present food delivery system 10, either immediately following cooking, or after an intervening period of chilled storage, for transportation to a remote serving location and rethermalization of the food to be ready for service at a pre-designated time. As explained above, the food delivery system 10 is uniquely adapted for use in holding or rethermalizing food either in bulk form still contained within large cooking pans or in the form of portioned individualized meals already placed on serving plates S. Further flexibility is provided by the provision of separate sets of electrical contacts for actuating each shelf 34 and separate contacts for each conduction heating unit 36 on each shelf, whereby it is possible to differentially operate the conduction heating units 36 from one shelf 34 to another, or even within the same shelf 34, e.g., so as to accommodate rethermalization or holding of pans P and/or plates S of differing types of food at the same time. In sum, there is essentially no reasonably foreseeable mode of operation for preparation of bulk food for banquets and the like for which the food delivery system 10 is not fully adapted and capable of satisfactory operation. Thus, the food delivery system 10, in appropriate circumstances, can enable substantial savings in efficiency, capital equipment expenditures, and cost of operation in comparison to conventional bulk food preparation systems.

As persons skilled in the art will also recognize and understand, the food delivery system 10 and its method of operation in accordance with the present invention are readily capable of being adapted to other forms of food preparation and service equipment than the cart embodiment of FIG. 1. As representatively depicted in FIG. 5, by way of example, but without limitation, the present food delivery system 10 may also be readily embodied in a food service cart 112 of the type utilized for transporting and serving individualized meals on serving trays, such as are known to be used in institutional settings such as hospitals, nursing homes, airlines, etc. The food service cart 112 of FIG. 5 is generally of the same type as disclosed in U.S. Pat. Nos. 4,180,125; 4,346,756; and RE.30,623. Specifically, the cart 112 of FIG. 5 has a housing 122 defined by side, rear, top and bottom walls 124, 126, 128, 130, defining an interior enclosure 114 closeable by a door 132 (optionally, doors may be provided at both the front and rear of the cart 112). However, in contrast to the cart 12 of FIG. 1, the cart 112 is not equipped with slideable food storage shelves but rather has a series of spaced horizontal rails 131 adapted to provide for sliding into and out of the enclosure 114 of food service trays T on which meals are supported via specially designed containers 135 securable in mated specially-designed slots, detents, grooves or the like form in the trays T, all as more fully described and known from the aforesaid prior patents. Conduction-type heating plates 136 are mounted to one side wall 124 of the cart 112 respectively adjacent the rails 131 at the same side of the cart 112 to engage beneath the containers 135 for purposes of heating the containers sufficiently to maintain the food therewithin at its designated serving temperature. These characteristics of the cart 112 are more fully described and known from the aforesaid U.S. Patents, the disclosures of which are incorporated herein by reference.

In accordance with the present invention, the cart 112 is modified from that described in the aforesaid patents by the provision of a central vertically-extending wall 145 dividing the interior enclosure 114 into left and right side compartments 114A and 114B. In the illustrated embodiment, the right side compartment 114B is designated for multi-function chilling, convection and conduction heating operation in substantially the same manner as described above with regard to the embodiment of FIG. 1, while the left side compartment 114A without the conduction heating plates 136 is designated for only chilling operation. The cart 112 is equipped with a food treatment system 16 and a coordinated programmable control system 18 of substantially the same basic componentry and arrangement as shown in FIG. 2 for the cart 12 of the embodiment of FIG. 1. More specifically, the condenser 52 and the blower 54 are adapted for circulating chilled air within both compartments 114A, 114B in the same manner as described above for the embodiment of FIG. 1. As may be desirable, separate condensers and blowers 52 may be provided for each compartment 114A, 114B. The conduction heating units 136 in the cart 112 serve substantially the same purpose and function and operate in substantially the same manner as the conduction heating units 36 of the shelves 34 and the cart 12 of FIG. 1. A convection heating unit 56 is provided for the compartment 114B to enable convection only and also simultaneous convection and conduction heating of the compartment 114B, e.g., for rethermalization or holding modes of operation. The operational componentry for the food treatment system 16 and the programmable control system 18 are appropriately mounted within the housing 122 in any suitable manner, but not shown in FIG. 5 for sake of simplicity.

As will thus be understood, the cart 112 as modified in accordance with the present invention provides improved, enhanced and optimized capabilities and flexibility in comparison to the known carts from the aforementioned prior patents. Specifically, the trays T can be equipped on one side with food which does not require cooking or heating but instead is desirable to maintain at a refrigerated temperature, e.g., salads, gelatins, soft drinks, and the like, whereas the tray T can be equipped on the opposite side with cooked food in the containers 135 which must be rethermalized and/or maintained at a heated serving temperature. When the trays T as so equipped are slid into the enclosure 114 via the rails 131, the central dividing wall 145 separates the chilled food into the left side compartment 114A and the cooked food into the right side compartment 114B. Depending upon whether the food within the containers 135 has been stored in a chilled environment so as to require rethermalization or instead is still at its cooked serving temperature, the food treatment system 16 may be operated via the programmable control system 18 in either a rethermalization mode, comparable to the “Plated ReTherm Mode,” to rethermalize food which has been stored in a chilled environment, or in a holding mode, comparable to the “Plated Hold Mode,” to maintain cooked food at its desired serving temperature. As necessary or desirable, the compartment 114 may be initially chilled in a rethermalization mode if the actuation of the preheating and rethermalization steps does not need to begin immediately. The compartment 114A will typically be chilled continuously throughout the operation of the cart 112.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements, the present invention being limited only by the claims appended hereto and the equivalents thereof.

What is claimed is:

1. A food delivery system for storing of food and heating of food to a serving temperature, the food delivery system comprising:
a) a transportable food storage unit defining an enclosure for containing a food item;
b) a food treatment system for determining food treatment conditions within the enclosure of the food storage unit, the food treatment system comprising:
(i) an arrangement for chilling the enclosure sufficiently to preserve temporarily the food item within the enclosure against spoilage,
(ii) an arrangement for heating by conduction the food item within the enclosure, and
(iii) an arrangement for heating by convection the food item within the enclosure; and
c) a programmable control system for controlling operation of the food treatment system, the control system being adapted for selectively determining an operating sequence, timing and duration of the chilling, conduction and convection arrangements according to the food item.

2. A food delivery system according to claim 1, wherein the transportable food storage unit comprises a food service cart.

3. A food delivery system according to claim 1, wherein the enclosure is adapted to support individualized meals on respective serving plates.

4. A food delivery system according to claim 1, wherein the enclosure is adapted to support bulk food cooking pans.

5. A food delivery system according to claim 1, wherein the transportable food storage unit comprises a second enclosure for containing another food item, and the chilling arrangement of the food treatment system is adapted to chill the second enclosure.

6. A food delivery system according to claim 1, wherein the programmable control system is arranged to execute operation of the food treatment system in a mode for rethermalizing chilled previously-cooked food to a serving temperature.

7. A food delivery system according to claim 1, wherein the programmable control system is arranged to execute operation of the food treatment system in a mode for holding previously cooked food at a serving temperature.

8. A food delivery system according to claim 1, wherein the programmable control system is arranged to execute operation of the food treatment system in a mode for rethermalizing to a serving temperature chilled previously-cooked meals individually supported or respective serving plates.

9. A food delivery system according to claim 1, wherein the programmable control system is arranged to execute operation of the food treatment system in a mode for cooking uncooked food to a serving temperature.

10. A food delivery system according to claim 1, wherein the programmable control system is arranged to execute operation of the food treatment system selectively in each of the following modes:
(i) a mode for rethermalizing chilled previously-cooked food to a serving temperature;
(ii) a mode for holding previously cooked food at a serving temperature;
(iii) a mode for cooking uncooked food to a serving temperature.

11. A food delivery system according to claim 1, wherein the programmable control system is arranged to execute operation of the food treatment system in a sequence wherein the chilling arrangement is initially actuated for a predetermined period of time, and thereafter the convection and conduction heating arrangements are actuated simultaneously for a subsequent predetermined period of time.

12. A food delivery system according to claim 11, wherein the programmable control system is arranged to actuate the convection heating arrangement for an intervening predetermined period of time after actuation of the chilling arrangement and before simultaneous actuation of the convection and conduction heating arrangements.

13. A food delivery system according to claim 1, wherein the programmable control system is arranged to execute operation of the food treatment system in a sequence wherein the convection heating arrangement only is actuated initially for a predetermined period of time, and thereafter the convection and conduction heating arrangements are actuated simultaneously for a subsequent predetermined period of time.

14. A food delivery system according to claim 1, wherein the programmable control system is arranged to execute operation of the food treatment system in a mode wherein the convection and conduction heating arrangements are actuated simultaneously.

15. A food delivery method of storing food and heating food to a serving temperature, the food delivery method comprising:
a) providing a food delivery system comprising a transportable food storage unit defining an enclosure containing the food to be stored and heated;
b) initially chilling the enclosure of the food storage unit sufficiently to preserve temporarily the food within the enclosure against spoilage for a predetermined period of time; and
c) thereafter heating the food in the enclosure by convection and conduction simultaneously for a subsequent predetermined period of time to a serving temperature for the food.

16. A food delivery method according to claim 15, further comprising the steps of, after initially chilling the enclosure and before simultaneously convection and conduction heating of the food, heating the food by only convection for an intervening predetermined period of time.

17. A food delivery method according to claim 15, further comprising the step of initially preparing and loading the food into the enclosure at a location remote to a serving location, and then transporting the food storage unit to the serving location.

18. A food delivery method according to claim 17, wherein the steps of initially preparing and loading the food comprises cooking the food prior to loading into the enclosure, and the step of heating the food comprises rethermalizing the cooked food to a serving temperature.

19. A food delivery method according to claim 18, wherein the step of initially preparing and loading the food comprises placing individualized meals of the food on respective serving plates.

20. A food delivery system method according to claim 18, wherein the step of initially preparing and loading the food comprises placing the food in bulk form in cooking pans.
